(19) United States
(12) Patent Application Publication
(10) Pub. No.: US 2006/0209975 A1
(43) Pub. Date: Sep. 21, 2006

(54) Multiple antenna communication system

(75) Inventors: Hong-Sil Jeong, Seoul (KR); Chan-Byoung Chae, Seoul (KR); Sung-Ryul Yun, Suwon-si (KR); Dong-Seek Park, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/304,096

(22) Filed: Dec. 15, 2005

(30) Foreign Application Priority Data
Dec. 15, 2004 (KR) 10-2004-0106020

(51) Int. Cl. H04K 1/10; H04L 1/02

(52) U.S. Cl. 375/260; 375/267

(57) ABSTRACT

A multiple antenna communication system is provided. In the multiple antenna communication system, a receiver selects a transmit eigenvector corresponding to a singular value resulting from the Singular Value Decomposition (SVD) of a channel matrix between Tx antennas and Rx antennas and feeds back the transmit eigenvector to a transmitter to assist the transmitter in selecting transmission data. Thus, the efficiency of data transmission is increased.

### PRIORITY

This application claims priority under 35 U.S.C. § 119 to an application entitled “Multiple Antenna Communication System” filed in the Korean Intellectual Property Office on Dec. 15, 2004 and assigned Serial No. 2004-106020, the contents of which are incorporated herein by reference.

### BACKGROUND OF THE INVENTION

1. Field of the Invention

The present invention relates generally to a multiple antenna communication system with a plurality of transmit (Tx) antennas and a plurality of receive (Rx) antennas, and in particular, to a multiple antenna communication system for increasing the efficiency of data transmission, in which a receiver selects a transmit eigenvector corresponding to a singular value resulting from the Singular Value Decomposition (SVD) of a channel matrix between Tx antennas and Rx antennas and feeds back the transmit eigenvector to a transmitter to assist the transmitter in selecting transmission data.

2. Description of the Related Art

The provisioning of wireless multimedia service in a broadband spectrum involves Inter-Symbol Interference (ISI) introduced by multipath propagation. The ISI decreases the transmission efficiency of the whole system. As an approach to solving the ISI, the OFDM (Orthogonal Frequency Division Multiplexing) scheme was proposed. In OFDM, the total frequency band is divided into multiple subcarriers, for transmission. As the duration of a symbol is increased, OFDM can minimize the ISI.

OFDM is a special case of Multi-Carrier Modulation (MCM) in which a serial symbol sequence is converted to parallel symbol sequences and modulated to mutually orthogonal subcarriers, prior to transmission. In view of difficulty in orthogonal modulation between multiple carriers, OFDM has limitations in applications to real systems. However, in 1971, Weinstein, et. al. proposed an OFDM scheme that applies Discrete Fourier Transform (DFT) to parallel data transmission as an efficient modulation/demodulation process, which was a driving force behind the development of OFDM. Also, the introduction of a guard interval and a cyclic prefix as a specific guard interval further mitigated adverse effects of multi-path propagation and delay spread on systems. Accordingly, OFDM has been exploited in wide fields of digital data communications such as Digital Audio Broadcasting (DAB), digital TV broadcasting, Wireless Local Area Network (WLAN), and Wireless Asynchronous Transfer Mode (WATM). Although hardware complexity was an obstacle to the widespread use of OFDM, recent advances in digital signal processing technology including Fast Fourier Transform (FFT) and Inverse Fast Fourier Transform (IFFT) have enabled OFDM implementation.

OFDM, similar to Frequency Division Multiplexing (FDM), boasts optimum transmission efficiency in high-speed data transmission because notably, it transmits data on sub-carriers, maintaining orthogonality among them. Especially, efficient frequency use attributed to overlapping frequency spectrums and robustness against frequency selective fading and multi-path fading further increase transmission efficiency in high-speed data transmission. Because OFDM reduces the effects of ISI by use of guard intervals, it is increasingly utilized in communication systems.

Meanwhile, Orthogonal Frequency Division Multiple Access (OFDMA) is a multiple access scheme based on OFDM. In OFDMA, some of the total subcarriers are grouped into a subcarrier set and allocated to a particular Access Terminal (AT). The subcarrier set can be dynamically allocated to the AT according to the fading characteristics of a radio transmission link in OFDMA. This is called dynamic resource allocation.

The use of multiple Tx and Rx antennas were proposed for high-speed data transmission. Starting with a Space-Time Coding (STC) proposed by Tarokh in 1997, space-time techniques have been developed to increase data rate, including Bell Lab Layered Space Time (BLAST) devised by Bell Labs. Especially since BLAST increases data rate in linear proportion to the number of Tx/Rx antennas, it finds its use in systems aiming at high-speed data transmission.

Existing BLAST algorithms are performed in an open loop. Because the aforementioned dynamic resource allocation is impossible in the open-loop BLASTs, closed-loop techniques have been developed recently. A major example is Singular Value Decomposition-Multiple Input Multiple Output (SVD-MIMO).

For better understanding of SVD-MIMO, a description will first be made of SVD, following an overview of EigenValue Decomposition (EVD). For any mxm square matrix A, there exists an mx1 vector x and a complex number λ such that Equation (1) is satisfied:
Ax=λx (1)

λ is called an eigenvalue of A and x is called an eigenvector of A. λ satisfies Equation (2):
det(A−λI)=0 (2)
where det denotes the determinant of a matrix and I denotes an identity matrix. x is calculated by Equation (1) using λ obtained from Equation (2). For example, in Equation (3), for a matrix

$$A = [ \begin{matrix}4 & - 5 \\ 2 & - 3\end{matrix} ]$$

$$det ( A - λ I ) = det [ \begin{matrix}4 - λ & - 5 \\ 2 & - 3 - λ\end{matrix} ] = {λ}^{2} - λ - 2 \\ {λ}_{1} = - 1 , {λ}_{2} = 2 \qquad ( 3 )$$

The eigenvector for λ₁ is shown in Equation (4):

$$( A - λ I ) x = [ \begin{matrix}5 & - 5 \\ 2 & - 2\end{matrix} ] [ \begin{matrix}y \\ z\end{matrix} ] = [ \begin{matrix}0 \\ 0\end{matrix} ] ; {X}_{1} = [ \begin{matrix}1 \\ 1\end{matrix} ] \qquad ( 4 )$$

For λ₂, the eigenvector is shown in Equation (5):

$$( A - λ I ) x = [ \begin{matrix}2 & - 5 \\ 2 & - 5\end{matrix} ] [ \begin{matrix}y \\ z\end{matrix} ] = [ \begin{matrix}0 \\ 0\end{matrix} ] ; {X}_{2} = [ \begin{matrix}5 \\ 2\end{matrix} ] \qquad ( 5 )$$

The above procedure for calculating eigenvalues and eigenvectors is summarized as follows.

Step 1: the determinant of (A−λI) is calculated.

Step 2: eigenvalues are calculated using the root of Step 1.

Step 3: eigenvectors corresponding to the eigenvalues are calculated such that Ax=λx.

If the eigenvectors are linearly independent, A can be decomposed into the eigenvalues and the eigenvectors.

A matrix D with the eigenvalues as diagonal elements and zeroes as the remaining elements is expressed as Equation (6):

$$D = [ \begin{matrix}{λ}_{1} & 0 & ⋯ & 0 \\ 0 & {λ}_{2} & ⋯ & 0 \\ ⋮ & ⋮ & ⋯ & ⋮ \\ 0 & 0 & ⋯ & {λ}_{m}\end{matrix} ] \qquad ( 6 )$$

A matrix S whose columns are the eigenvectors is shown in Equation (7):
S=[x₁x₂ . . . xₘ] (7)

Based on the matrices D and S, the matrix A is expressed as shown in Equation (8):
A=SDS⁻¹ (8)
Thus, as shown in Equation (9), for the above example

$$\begin{matrix}A = [ \begin{matrix}4 & - 5 \\ 2 & - 3\end{matrix} ] , \\ A = [ \begin{matrix}4 & - 5 \\ 2 & - 3\end{matrix} ] = {[ \begin{matrix}1 & 5 \\ 1 & 2\end{matrix} ] [ \begin{matrix}- 1 & 0 \\ 0 & 2\end{matrix} ] [ \begin{matrix}1 & 5 \\ 1 & 2\end{matrix} ]}^{- 1}\end{matrix} \qquad ( 9 )$$

In conjunction with the EVD, SVD will be described now. While the EVD is defined for a square matrix, the SVD is a decomposition similar to the EVD, defined for a non-square mxn matrix (where m is different from n).

A non-square matrix B is factorized as shown in Equation (10) into
B=UDV^{H} (10)
where U denotes an mxm unitary matrix having the eigenvectors of BB^{H} as columns and V denotes an nxn unitary matrix having the eigenvectors of B^{H}B as columns. The diagonal elements of the diagonal matrix D are the singular values of A. The singular values are the square roots of non-zero singular values of BB^{H} or B^{H}B.

How the SVD is applied to the channel matrix of a MIMO system will now be described. As stated earlier, this system is called an SVD-MIMO system. It is to be noted herein that the terms “data” and “symbol” are used in the same sense and thus they are interchangeable in the following description.

For N_{T} Tx antennas and N_{R} Rx antennas in the MIMO system, a channel H on which data is transmitted from a transmitter before arriving at a receiver can be said to be an N_{R}xN_{T} random matrix. By the SVD of the channel matrix H, Equation (11) is satisfied:
H=UDV^{H} (11)
where U denotes an N_{R}xN_{R} unitary matrix with the eigenvectors of HH^{H} as columns, called a receive eigenvector matrix, and V denotes an N_{T}xN_{T} unitary matrix with the eigenvectors of H^{H}H as columns, called a transmit eigenvector matrix. The diagonal elements of the diagonal matrix D are the singular values of H. The singular values are the square roots of non-zero singular values of HH^{H} or H^{H}H. Thus, the diagonal matrix D is called a singular value matrix.

In general, the transmission and reception of a multiple antenna communication system is in the relationship of Equation (12):
Y=HX+N (12)
where Y denotes an N_{R}x1 receive symbol matrix, X denotes an N_{T}x1 transmit symbol matrix, H is the N_{R}xN_{T} channel matrix, and N denotes an N_{R}x1 Additive White Gaussian Noise (AWGN) matrix. The transmit symbol matrix X is delivered on the channel of the matrix H and added with the noise component matrix N, prior to arriving at the receiver.

For application of the SVD to the SVD-MIMO system, the transmitter uses a pre-filter configured in the form of a matrix V. Thus, the transmit symbol matrix is shown in Equation (13):
X′=V·X (13)

As the receiver uses a post-filter configured in the form of a matrix U^{H}, the receive symbol matrix is given as shown in Equation (14):
Y′=U^{H}·Y (14)

In the SVD-MIMO system using the matrix V in a pre-filter at the transmitter and the matrix U^{H} as in post-filter at the receiver, the transmit matrix and the receive matrix are in the following relationship of Equation (15):

$$\begin{matrix}{Y}^{′} = {U}^{H} \cdot Y = {U}^{H} HVX + {U}^{H} N \\ = {U}^{H} {UDV}^{H} VX + {U}^{H} N \\ = DX + {U}^{H} N\end{matrix} \qquad ( 15 )$$

Assuming that N_{T}≦N_{R}, in component notation, the matrices shown in Equation (15) are set forth as Equation (16):

$${Y}^{′} = [ \begin{matrix}{y}_{1}^{′} \\ {y}_{2}^{′} \\ ⋮ \\ {y}_{{N}_{R}}^{′}\end{matrix} ] [ \begin{matrix}{λ}_{1} & 0 & ⋯ & 0 \\ 0 & {λ}_{2} & ⋯ & 0 \\ ⋮ & ⋮ & ⋯ & ⋮ \\ 0 & 0 & ⋯ & {λ}_{{N}_{T}} \\ 0 & 0 & 0 & 0\end{matrix} ] [ \begin{matrix}{x}_{1} \\ {x}_{2} \\ ⋮ \\ {x}_{{N}_{T}}\end{matrix} ] [ \begin{matrix}{n}_{1}^{′} \\ {n}_{2}^{′} \\ ⋮ \\ {n}_{{N}_{R}}^{′}\end{matrix} ] \qquad ( 16 )$$

As noted from Equation (16), it can be said that the SVD-MIMO system is a set of multiple Single Input Single Output (SISO) systems. According to the relationship between the matrix X′ being the product of the transmit symbol matrix and the matrix V and the matrix Y′ being the product of the receive symbol matrix and the matrix U^{H}, the channel matrix H is simplified to the matrix D whose diagonal elements are eigenvalues fewer than or as many as min(N_{T}, N_{R}). In the case where the channel matrix H is decomposed by SVD and the transmitter and the receiver use a pre-processor and a post-processor, respectively, the transmitter can simplify a MIMO channel to a plurality of SISO channels, for easy interpretation, if the transmit eigenvector matrix V is known. In other words, the SVD-MIMO system can be implemented as a plurality of SISO systems each using a singular value λᵢ, as a channel value. If the transmitter knows the transmit eigenvector matrix V and the singular value λᵢ, optimum dynamic resource allocation is possible. Needless to say, the receiver must feed back information about the transmit eigenvector matrix V and the singular value λᵢ to the transmitter.

With reference to FIG. 1, an example of an OFDM system using the above-described SVD will be described. FIG. 1 is a block diagram of a transmitter and a receiver in a conventional multiple Tx and Rx antenna system. In the illustrated case, the SVD-MIMO scheme is applied to an OFDM system, by way of example, although it is applicable to any other communication scheme (e.g. CDMA, TDMA, and FDMA) using multiple Tx and Rx antennas.

Transmission data is first encoded and modulated in a predetermined channel encoder and modulator, prior to transmission. For conciseness, the subsequent transmission procedure after coding and modulation is shown in FIG. 1.

Referring to FIG. 1, a serial-to-parallel (S/P) converter 101 converts a sequence of modulation symbols (i.e. information data) to parallel symbols. A pre-processor 103 multiplies the parallel symbols by the matrix V achieved from the SVD of the channel matrix H by Equation (13). A plurality of IFFT processors 105a to 105n, which are mapped to respective TX antennas 109a to 109n, IFFT-process the products. The IFFT signals are transmitted to a receiver through a plurality of parallel-to-serial (P/S) converters 107a to 107n and the Tx antennas 109a to 109n.

The transmitted signals are received at a plurality of (e.g. N_{R}) Rx antennas 111a to 111m. The signal transmitted from the first Tx antenna 109a (Tx 1) is received at the N_{R}Rx antennas 111a to 111m on different channels. Similarly, each of the signals transmitted from the second to N_{T}^{th} Tx antennas 109b to 109n is received at the N_{R} Rx antennas. The channels between the Tx antennas and the Rx antennas is given as the channel matrix H of Equation (17):

$$H = [ \begin{matrix}{H}_{11} & {H}_{12} & ⋯ & {H}_{1 N} \\ {H}_{21} & {H}_{22} & ⋯ & {H}_{2 N} \\ ⋯ & & & \\ {H}_{M 1} & {H}_{M 2} & ⋯ & {H}_{MN}\end{matrix} ] \qquad ( 17 )$$

That is, the transmitted signals arrive at the N_{R} Rx antennas on the channel H. A plurality of S/P converters 113a to 113m parallelize the received signals. FFT processors 115a to 115m FFT-process the parallel signals. A post-processor 117 multiplies the FFT signals by the matrix U^{H} according to the afore-described SVD. A P/S converter 119 serializes the products. The receiver estimates the channel values between the Tx antennas and the Rx antennas and computes the matrices V, D and U through the SVD of the channel matrix H. The receiver then feeds back the matrices V and D to the transmitter. The transmitter performs an optimum resource allocation algorithm using the singular values λᵢ being the diagonal elements of the matrix D. However, the feedback of both the matrices V and D requires a large amount of feedback information and a power control block, as well. If data is transmitted on a channel with a small singular value being a diagonal element of the matrix D, an error probability is increased, thereby seriously decreasing the efficiency of data transmission. Accordingly, a need exists for a method of efficiently transmitting data in the SVD-MIMO system.

### SUMMARY OF THE INVENTION

An object of the present invention is to substantially solve at least the above problems and/or disadvantages and to provide at least the advantages below. Accordingly, the present invention provides a transmitter for efficiently transmitting data using an eigenvector selected by SVD in a multiple Tx and Rx antenna communication system.

The present invention provides a receiver for enabling efficient data transmission of a transmitter based on an eigenvector selected by SVD in a multiple Tx and Rx antenna communication system.

The present invention provides a transmission method of efficiently transmitting data using an eigenvector selected by SVD in a multiple Tx and Rx antenna communication system.

The present invention provides a reception method for enabling efficient data transmission of a transmitter based on an eigenvector selected by SVD in a multiple Tx and Rx antenna communication system.

The above objects are achieved by providing a multiple antenna communication system.

According to one aspect of the present invention, in a transmitter in a communication system using a plurality of transmit antennas and a plurality of receive antennas, a transmission data selector selects input symbols based on transmit eigenvector selection information received from a receiver. The transmit eigenvector selection information indicates a transmit eigenvector selected according to singular values resulting from SVD of a channel matrix between the transmit antennas and the receive antennas. A pre-processor multiplies the selected symbols by an eigenvector matrix received from the receiver and outputs the products as pre-processed symbols. The eigenvector matrix is obtained by the SVD of the channel matrix. A signal processor processes the pre-processed symbols in a predetermined method and transmits the processed symbols through the transmit antennas.

According to another aspect of the present invention, in a receiver in a communication system using a plurality of transmit antennas and a plurality of receive antennas, a channel estimator estimates a channel matrix between the transmit antennas and the receive antennas from symbols received through the receive antennas from a transmitter. A singular value decomposer calculates a matrix V, a matrix D and a matrix U^{H} by SVD of the channel matrix. A signal processor processes the received symbols in a predetermined method. A post-processor multiplies the processed symbols by the matrix U^{H} and outputs the products as post-processed symbols. A transmit eigenvector decider selects a transmit eigenvector using singular values of the matrix D.

According to a further aspect of the present invention, in a transmission method for transmitter in a communication system using a plurality of transmit antennas and a plurality of receive antennas, symbols are selected among input symbols based on transmit eigenvector selection information received from a receiver. The transmit eigenvector selection information indicates a transmit eigenvector selected according to singular values resulting from SVD of a channel matrix between the transmit antennas and the receive antennas. The selected symbols are multiplied by an eigenvector matrix received from the receiver and output as pre-processed symbols. Here, the eigenvector matrix is obtained by the SVD of the channel matrix. The pre-processed symbols are processed in a predetermined method and transmitted through the transmit antennas.

According to still another aspect of the present invention, in a reception method for a receiver in a communication system using a plurality of transmit antennas and a plurality of receive antennas, a channel matrix between the transmit antennas and the receive antennas is estimated from symbols received through the receive antennas from a transmitter. A matrix V, a matrix D and a matrix U^{H} are calculated by SVD of the channel matrix. The received symbols are processed in a predetermined method and multiplied by the matrix U^{H} and the products are output as post-processed symbols. A transmit eigenvector is selected using singular values of the matrix D.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a transmitter and a receiver in a conventional multiple Tx and Rx antenna system;

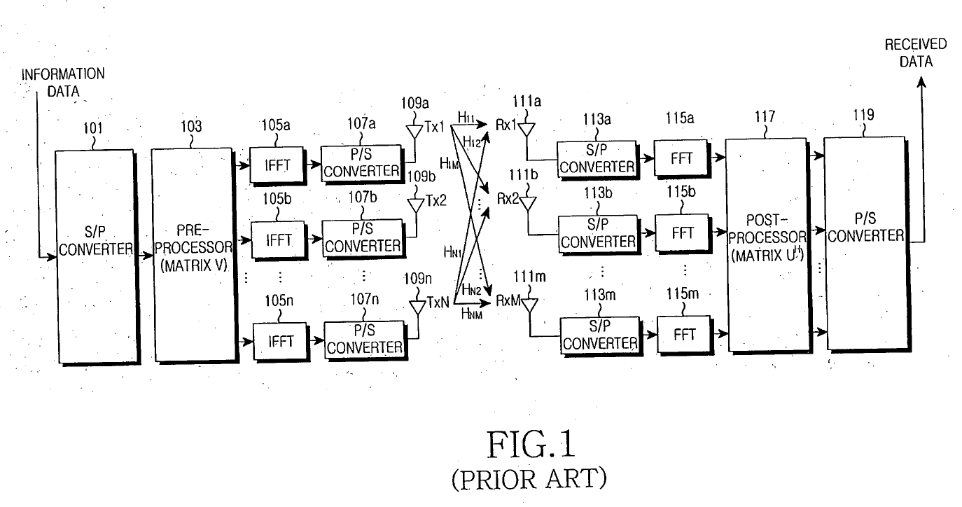

FIG. 2 is a block diagram of a transmitter and a receiver in a multiple Tx and Rx antenna system according to the present invention;

FIG. 3 is a flowchart illustrating a data transmission method in the transmitter of the multiple Tx and Rx antenna system according to the present invention;

FIG. 4 is a flowchart illustrating a data reception method in the receiver of the multiple Tx and Rx antenna system according to the present invention; and

FIG. 5 is a flowchart illustrating an operation for selecting a transmit eigenvector in the multiple Tx and Rx antenna system according to the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

The present invention pertains to a multiple antenna communication system for increasing the efficiency of data transmission, in which a receiver selects a transmit eigenvector corresponding to a singular value resulting from the SVD of a channel matrix between Tx antennas and Rx antennas and feeds back the transmit eigenvector to a transmitter to assist the transmitter in selecting transmission data. In particular, the present invention provides an apparatus and method for increasing the efficiency of data transmission by transmitting data using a transmit eigenvector selected by SVD in a closed-loop multiple antenna communication system.

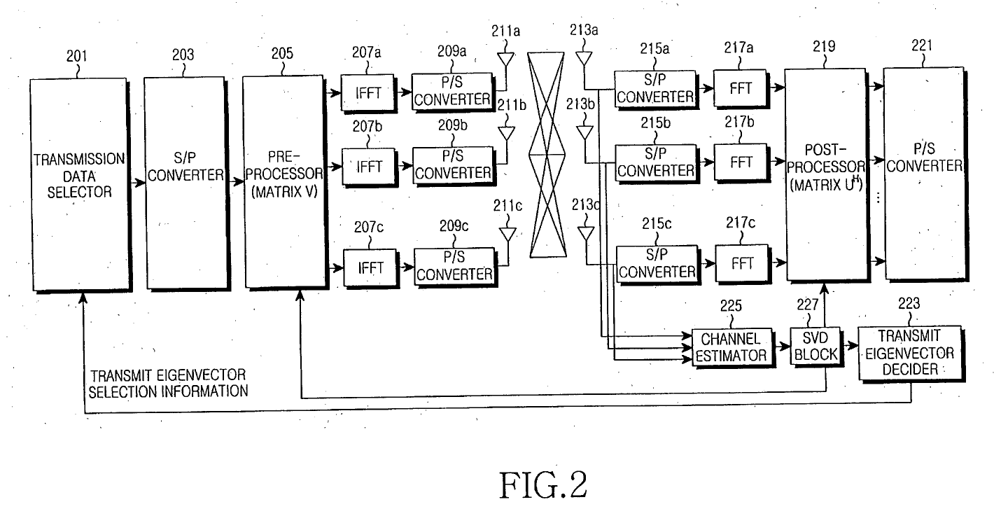

FIG. 2 is a block diagram of a transmitter and a receiver in a multiple Tx and Rx antenna system according to the present invention. Particularly, this multiple antenna system is a closed-loop SVD-MIMO communication system based on OFDM, while it is to be clearly understood that the present invention is applicable to other systems, such as CDMA and TDMA.

The illustrated configuration of the transmitter is confined to processes after modulation, including three Tx antennas for illustrative purposes. Referring to FIG. 2, a sequence of modulation symbols (i.e. information data) are provided to a transmission data selector 201. The transmission data selector 201 selects as many modulation symbols as the number of selected eigenvectors. An S/P converter 203 converts the selected modulation symbols to parallel symbols.

A pre-processor 205 multiplies the parallel symbols by a feedback matrix V received from the receiver. The products are transmitted to the receiver through three IFFT processors 207a, 207b, and 207c mapped to three (n=3) Tx antennas 211a, 211b and 211c, three P/S converters 209a, 209b and 209c, and the three Tx antennas.

The receiver is also shown to have three FFT processors, three S/P converters, and three Rx antennas, for illustrative purposes.

The transmitted data are received at three (M=3) Rx antennas 213a, 213b and 213c on a transmission channel H. Each of the received signals is converted to parallel signals in S/P converters 215a, 215b and 215c and FFT-processed in FFT processors 217a, 217b and 217c. A post-processor 219 multiplies the FFT signals by a matrix U^{H} obtained by the SVD of the channel matrix H. The products are serialized in a P/S converter 221.

For a system using two (N_{T}=2) Tx antennas and three (N_{R}=3) Rx antennas, if a channel matrix H is shown in Equation (18):

$$H = [ \begin{matrix}2 & 0 \\ 0 & - 3 \\ 0 & 0\end{matrix} ] = [ \begin{matrix}1 & 0 & 0 \\ 0 & - 1 & 0 \\ 0 & 0 & 1\end{matrix} ] [ \begin{matrix}2 & 0 \\ 0 & 3 \\ 0 & 0\end{matrix} ] [ \begin{matrix}1 & 0 \\ 0 & 1\end{matrix} ] \qquad ( 18 )$$

the singular values are 2 and 3. If a singular value of 2 is selected, the transmitter receives a transmit eigenvector of [1 0] corresponding to the singular value of 2 and the selected singular value of 2 from the receiver.

In operation at the receiver, data received at the Rx antennas 213a, 213b and 213c are parallelized in the S/P converters 215a, 215b, and 215c and FFT-processed in the FFT processors 217a, 217b and 217c. The FFT signals are multiplied by the matrix U^{H} resulting from the SVD of the channel matrix H in the post-processor 219 and serialized in the P/S converter 221. In the meantime, a channel estimator 225 estimates the channel matrix H between the Tx antennas 211a, 211b and 221c and the Rx antennas 213a, 213b and 213c. An SVD block 227 computes the matrices V, D and U by the SVD of the estimated channel matrix H. The SVD block 227 provides the Hermitian of the matrix U, U^{H} to the post-processor 219 and feeds back the matrix V to the pre-processor 205 of the transmitter. A transmit eigenvector decider 223 selects a transmit eigenvector from the data received from the SVD block 227 by analyzing the channel status of each antenna based on the singular values resulting from the SVD of the channel matrix H, and transmits transmit eigenvector selection information indicating the selected transmit eigenvector to the transmission data selector 201 of the transmitter.

A detailed description will now be made of the transmit eigenvector selection in the transmit eigenvector decider 223. The post-processor 219 multiplies the received signal by the matrix U^{H}, thus producing a signal (DX+UHN) described as Equation (15). As stated before, the diagonal elements of the matrix D are the singular values of H and the singular values are decreasingly ordered. Each of the singular values represents a channel condition depending on its value. The matrix D is expressed as shown in Equation (19):

$$D = [ \begin{matrix}{λ}_{1} & 0 & 0 & ⋯ & ⋯ & 0 \\ 0 & {λ}_{2} & 0 & ⋯ & ⋯ & 0 \\ ⋮ & ⋮ & {λ}_{r} & ⋯ & ⋯ & 0 \\ ⋮ & ⋮ & & ⋯ & ⋯ & 0 \\ 0 & 0 & 0 & {λ}_{{N}_{R}} & ⋯ & 0\end{matrix} ] if {N}_{T} > {N}_{R} or \\ D = [ \begin{matrix}{λ}_{1} & 0 & 0 & ⋯ \\ 0 & {λ}_{2} & 0 & ⋯ \\ ⋮ & ⋮ & {λ}_{r} & ⋯ \\ ⋮ & ⋮ & & ⋯ \\ 0 & 0 & 0 & {λ}_{{N}_{T}} \\ ⋮ & ⋮ & ⋮ & ⋮ \\ 0 & 0 & 0 & 0\end{matrix} ] if {N}_{T} \leq {N}_{R} \qquad ( 19 )$$

where r denotes the rank of the channel matrix H, r≦min(N_{T}, N_{R}). If r<min(N_{T}, N_{R}), λᵢ is all zeroes because r<i<(N_{T} or N_{R}) and r is the number of non-zero singular values. λᵢ, (1≦i≦r) is the singular value of H and if i>j, λᵢ>λᵢ.

The diagonal elements of the matrix D are decreasingly ordered. As noted from Equation (19), a MIMO channel can be transformed to a plurality of SISO channels, and λᵢ to λᵣ in the SVD-MIMO system of the present invention where the transmitter multiplies the matrix V by transmission data and the receiver multiplies the matrix U^{H} by received data. Thus, as the rank increases, the channel capacity also increases.

As stated before, λᵢ(1≦i≦r) is ordered according to its value indicating whether the channel condition of a corresponding Tx antenna is good or bad. In accordance with the present invention, if it is determined from λᵢ(1≦i≦r) that a Tx antenna is in a bad channel condition and does not satisfy a predetermined condition, data is not transmitted with a corresponding eigenvector.

Regarding the condition of determining the number of transmission data based on λ in the matrix D, the channel capacity C in the MIMO system is derived as shown in Equation (20):

$$C = W {\sum }_{i = 1}^{r} {log}_{2} ( 1 + \frac{{P}_{{r}_{1}}}{{σ}^{2}} ) \qquad ( 20 )$$

where W denotes the bandwidth of each subchannel, Pᵣ_{ₗ} denotes the received signal power of an i^{th} subchannel, and σ² denotes a channel noise variance. If each Tx antenna uses the same transmit power, Equation (21) is satisfied:

$${P}_{{r}_{1}} = \frac{{λ}_{i} P}{{N}_{T}} \qquad ( 21 )$$

where P denotes the total transmit power. If the SVD-MIMO system chooses K≦N_{T} eigenvectors rather than uses all N_{T} eigenvectors, the elements of (K+1)^{th} to N_{T}^{th} rows in an N_{T}x1 transmission data vector can be considered to be zeroes. With respect to the same transmit power as that used for transmitting N_{T} data in a MIMO system, the reception power of K data in the SVD-MIMO system is shown is Equation (22):

$${P}_{{r}_{1}} = \frac{{λ}_{i} P}{K} \qquad ( 22 )$$

Thus, the channel capacity C_{K} in this SVD-MIMO system is given as Equation (23):

$${C}_{K} = W {\sum }_{i = 1}^{r} {log}_{2} ( 1 + \frac{{λ}_{i} P}{K {σ}^{2}} ) \qquad ( 23 )$$

where W denotes the bandwidth of each subchannel, λᵢ denotes the singular values of the channel matrix, σ² denotes a channel noise variance, P denotes the total transmit power, and K is the number of transmission data.

The channel capacity is computed over all cases satisfying 1≦K≦r according to Equation (23) and K is selected which offers the highest channel capacity. As stated before, K is equal to the number of the columns of the transmit eigenvector matrix V used in the pre-processor. While the conventional SVD-MIMO system entirely transmits an N_{T}xN_{T} transmit eigenvector matrix, a selective SVD-MIMO system of the present invention transmits an N_{T}xK transmit eigenvector matrix, thereby reducing the amount of transmission data. In addition, compared to the conventional SVD-MIMO system where feedback of the matrix D and a power control block are needed for power control based on λᵢ, there is no need for feeding back the matrix D, and the number of transmit eigenvectors is easily determined in the selective SVD-MIMO system.

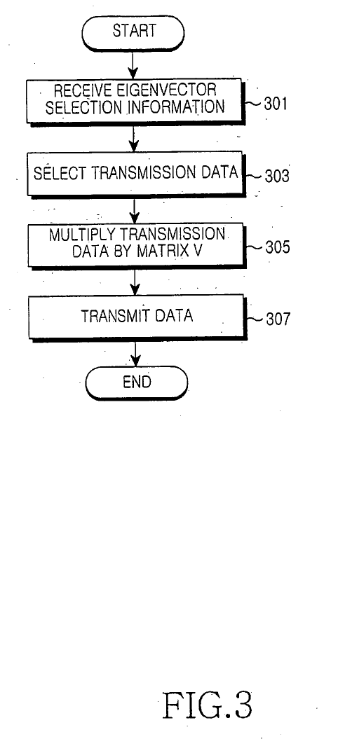

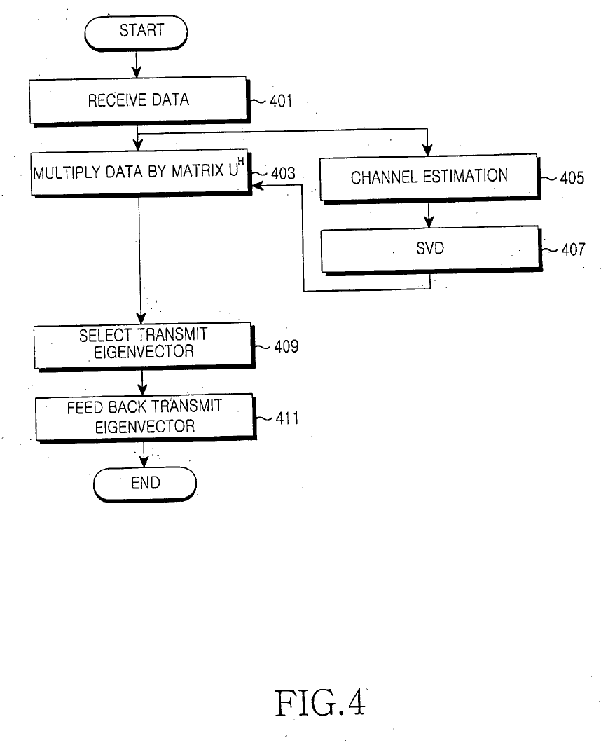

Now a description will be made of data transmission and reception according to an embodiment of the present invention with reference to FIGS. 3 and 4.

FIG. 3 is a flowchart illustrating a data transmission method for a transmitter in the multiple Tx and Rx antenna communication system according to an embodiment of the present invention.

Referring to FIG. 3, the transmitter first receives feedback eigenvector selection information from the receiver in step 301 and selects transmission symbols based on the eigenvector selection information in step 303. The transmitter then multiplies the transmission symbols by a feedback transmit eigenvector matrix V received from the receiver such that symbols are not mapped with respect to eigenvectors indicating a bad channel condition and thus excluded from transmission in step 305. The transmitter IFFT-processes the products, serializes the IFFT signals, and transmits the serial signal through Tx antennas in step 307.

As described above, singular values representing the channel statuses of the Tx antennas as the diagonal elements of the matrix D are calculated by the SVD of the channel matrix H and transmit eigenvectors are selected, which offer the largest channel capacity in accordance with Equation (23).

For example, for four Tx antennas and four Rx antennas (N_{T}=4 and N_{R}=4), symbols s₁, s₂, s₃ and s₄ are all transmitted at first. The matrix D is computed by Equation (13) to Equation (16) and transmit eigenvectors are selected which maximize the channel capacity according to Equation (20) to Equation (23). If the selected eigenvectors are #1, #2 and #3, the transmitter transmits data with the three eigenvectors until the receiver finds out the channel statuses of the Tx antennas the next time, that is, until the next transmit eigenvector determination. Thus, the transmission data selector 201 of the transmitter selects transmission symbols among input symbols s₅, s₆, s₇ and s₈ according to the transmit eigenvector selection information such that data can be transmitted only with the eigenvectors #1, #2 and #3. For this purpose, the transmission data selector 201 multiplies the input symbols by the following matrix shown in Equation (24):

$$[ \begin{matrix}1 & 0 & 0 & 0 \\ 0 & 1 & 0 & 0 \\ 0 & 0 & 1 & 0 \\ 0 & 0 & 0 & 1\end{matrix} ] \qquad ( 24 )$$

Consequently, only the symbols s₅, s₆ and s₇ are provided to the S/P converter 203. Here, the last symbol value is zero. That is, the symbol value multiplied by the last eigenvector is zero. Meanwhile, the next transmission must start with the symbol s₈ to ensure the continuity of symbol transmission. Thus, the transmission data selector 201 must memorize the non-transmitted symbol s₈. The transmission symbols are then multiplied by the matrix V in step 305 and transmitted in step 307.

As the channel condition varies, it is preferable that the transmit eigenvector selection information is periodically checked and updated.

FIG. 4 is a flowchart illustrating a data reception method in the receiver of the multiple Tx and Rx antenna communication system according to the present invention. Particularly, the data reception procedure is for a receiver in a selective SVD-MIMO system.

Referring to FIG. 4, the receiver receives data from the transmitter in step 401 and performs a channel estimation on the received data in step 405. In step 407, the receiver decomposes the estimated channel matrix H by SVD. The pre-processor of the receiver multiplies the received data by a matrix U^{H} obtained through the SVD in step 403. The channel estimated from the product takes the form of a matrix D. A matrix V is also computed by the SVD of the channel matrix H in step 407 and transmit eigenvectors are selected by Equation (20) through Equation (23) in step 409. The matrix V and the transmit eigenvector selection information are fed back to the transmitter in step 411.

In a TDD system, the transmitter can compute the matrix V and thus no feedback of the matrix V is needed. A base station and a mobile station use the same frequency band and information is exchanged between them repeatedly in the TDD system. Since there is little time difference between downlink data transmission and uplink data transmission, it can be assumed that the channel does not vary. This implies that the same matrix V is calculated in the base station and the mobile station. Therefore, the transmitter does not need to notify the receiver of the matrix V.

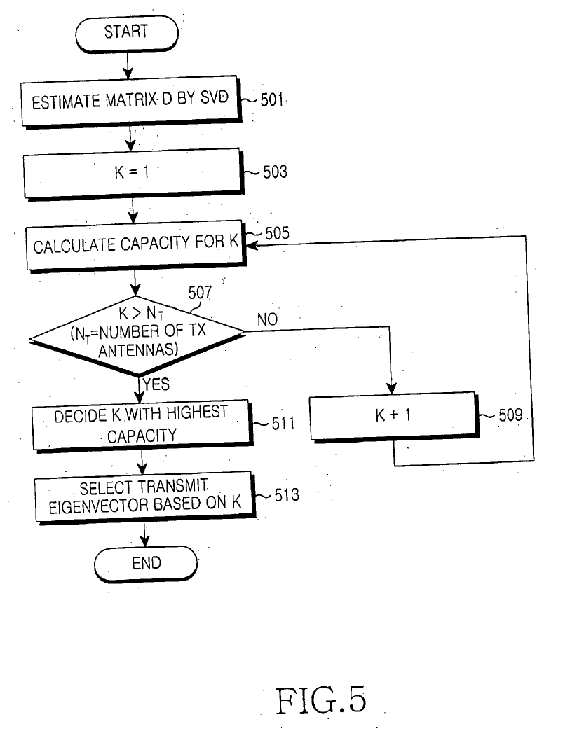

FIG. 5 is a flowchart illustrating an operation for selecting a transmit eigenvector in the multiple Tx and Rx antenna system according to the present invention. This operation takes place in the receiver of the closed-loop multiple Tx and Rx antenna communication system.

Referring to FIG. 5, a matrix D is estimated through the SVD of a channel matrix H estimated from received data in step 501 and K is set to an initial value 1 in step 503. In step 505, the channel capacity is calculated for K. If K is less than N_{T} in step 507, K is increased by 1 in step 509 and the procedure returns to step 505. If K is greater than N_{T}, K is selected which maximizes the channel capacity in step 511 and transmit eigenvectors are selected based on K in step 513.

In accordance with the present invention as described above, a receiver selects transmit eigenvectors that maximize channel capacity using singular values resulting from the SVD of the channel matrix between Tx antennas and Rx antennas and feeds back the selected transmit eigenvectors to a transmitter in a multiple antenna communication system. The transmitter selects transmission data based on the feedback information. Therefore, the efficiency of data transmission is increased.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A transmitter in a communication system using a plurality of transmit antennas, comprising:
a transmission data selector for selecting input symbols based on transmit eigenvector selection information received from a receiver, the transmit eigenvector selection information indicating a transmit eigenvector selected according to singular values resulting from singular value decomposition (SVD) of a channel matrix between the transmit antennas and the receive antennas;
a pre-processor for multiplying the selected symbols by an eigenvector matrix received from the receiver, the eigenvector matrix being obtained by the SVD of the channel matrix and outputting the products as pre-processed symbols; and
a signal processor for processing the pre-processed symbols and transmitting the processed symbols through the transmit antennas.

2. The transmitter of claim 1, further comprising a serial-to-parallel converter after the transmission data selector, for converting the selected symbols to parallel symbols.

3. The transmitter of claim 1, wherein the signal processor comprises an inverse fast Fourier transform (IFFT) processor and a parallel-to-serial converter.

4. The transmitter of claim 1, wherein the transmission data selector memorizes an unselected symbol and processes the unselected symbol first in a next transmission period.

5. The transmitter of claim 1, wherein the transmit eigenvector selection information is periodically changed according to the channel statuses of the transmit antennas and the receive antennas.

6. The transmitter of claim 1, wherein the selected transmit eigen vector maximizes a channel capacity calculated by
$${C}_{K} = W {\sum }_{i = 1}^{r} {log}_{2} ( 1 + \frac{{λ}_{i} P}{K {σ}^{2}} )$$
where C_{K} denotes the channel capacity, W denotes the bandwidth of each subchannel, λᵢ denotes the singular values of a channel matrix, σ² denotes a channel noise variance, P denotes total transmit power, and K is the number of transmission data.

7. A receiver in a communication system using a plurality of receive antennas, comprising:
a channel estimator for estimating a channel matrix between the transmit antennas and the receive antennas from symbols received through the receive antennas from a transmitter;
a singular value decomposer for calculating a matrix V, a matrix D and a matrix U^{H} by singular value decomposition (SVD) of the channel matrix;
a signal processor for processing the received symbols;
a post-processor for multiplying the processed symbols by the matrix U^{H} and outputting the products as post-processed symbols; and
a transmit eigenvector decider for selecting a transmit eigenvector using singular values of the matrix D.

8. The receiver of claim 7, further comprising a parallel-to-serial converter after the post-processor, for converting the post-processed symbols to serial symbols.

9. The receiver of claim 7, wherein the signal processor comprises a serial-to-parallel converter and a fast Fourier transform (FFT) processor.

10. The receiver of claim 7, wherein the transmit eigenvector decider periodically selects a transmit eigenvector according to the channel statuses of the transmit antennas and the receive antennas.

11. The receiver of claim 7, wherein the transmit eigenvector decider selects the transmit eigenvector which maximizes a channel capacity calculated by
$${C}_{K} = W {\sum }_{i = 1}^{r} {log}_{2} ( 1 + \frac{{λ}_{i} P}{K {σ}^{2}} )$$
where C_{K} denotes the channel capacity, W denotes the bandwidth of each subchannel, λᵢ denotes the singular values of a channel matrix, σ² denotes a channel noise variance, P denotes total transmit power, and K is the number of transmission data.

12. A transmission method for a transmitter in a communication system using a plurality of transmit antennas, comprising the steps of:
selecting input symbols based on transmit eigenvector selection information received from a receiver, the transmit eigenvector selection information indicating a transmit eigenvector selected according to singular values resulting from singular value decomposition (SVD) of a channel matrix between the transmit antennas and the receive antennas;
multiplying the selected symbols by an eigenvector matrix received from the receiver, the eigenvector matrix being obtained by the SVD of the channel matrix and outputting the products as pre-processed symbols; and
processing the pre-processed symbols and transmitting the processed symbols through the transmit antennas.

13. The transmission method of claim 12, further comprising the step of converting the selected symbols to parallel symbols.

14. The transmission method of claim 12, wherein the processing step comprises the steps of inverse fast Fourier transform (IFFT)-processing the pre-processed symbols and converting parallel IFFT signals to serial IFFT signals.

15. The transmission method of claim 12, wherein the selected transmit eigen vector maximizes a channel capacity calculated by
$${C}_{K} = W {\sum }_{i = 1}^{r} {log}_{2} ( 1 + \frac{{λ}_{i} P}{K {σ}^{2}} )$$
where C_{K} denotes the channel capacity, W denotes the bandwidth of each subchannel, λᵢ, denotes the singular values of a channel matrix, σ² denotes a channel noise variance, P denotes total transmit power, and K is the number of transmission data.

16. A reception method for a receiver in a communication system using a plurality of receive antennas, comprising the steps of:
estimating a channel matrix between the transmit antennas and the receive antennas from symbols received through the receive antennas from a transmitter;
calculating a matrix V, a matrix D and a matrix U^{H} by singular value decomposition (SVD) of the channel matrix;
processing the received symbols;
multiplying the processed symbols by the matrix U^{H} and outputting the products as post-processed symbols; and
selecting a transmit eigenvector using singular values of the matrix D.

17. The reception method of claim 16, further comprising the step of converting the post-processed symbols to serial symbols.

18. The reception method of claim 16, wherein the processing step comprises the steps of converting the received symbols to parallel symbols and fast Fourier transform (FFT)-processing the parallel symbols.

19. The reception method of claim 16, wherein the selected transmit eigenvector is changed periodically according to the channel statuses of the transmit antennas and the receive antennas.

20. The reception method of claim 16, wherein the transmit eigenvector selecting step comprises the step of selecting a transmit eigenvector which maximizes a channel capacity calculated by
$${C}_{K} = W {\sum }_{i = 1}^{r} {log}_{2} ( 1 + \frac{{λ}_{i} P}{K {σ}^{2}} )$$
where C_{K} denotes the channel capacity, W denotes the bandwidth of each subchannel, λᵢ denotes the singular values of a channel matrix, σ² denotes a channel noise variance, P denotes total transmit power, and K is the number of transmission data.
